(19) United States
(12) Patent Application Publication
(10) Pub. No.: US 2025/0050442 A1
(43) Pub. Date: Feb. 13, 2025

(54) ABNORMALITY DIAGNOSIS APPARATUS, ABNORMALITY DIAGNOSIS METHOD, AND STORAGE MEDIUM

(71) Applicant: NEC Corporation, Minato-ku, Tokyo (JP)

(72) Inventors: Hiroki TAGATO, Tokyo (JP); Yoshiaki SAKAE, Tokyo (JP); Takashi KONASHI, Tokyo (JP); Jun NISHIOKA, Tokyo (JP); Yuji KOBAYASHI, Tokyo (JP); Jun KODAMA, Tokyo (JP); Etsuko ICHIHARA, Tokyo (JP)

(73) Assignee: NEC Corporation, Minato-ku, Tokyo (JP)

(21) Appl. No.: 18/715,789

(22) PCT Filed: Dec. 7, 2021
(86) PCT No.: PCT/JP2021/044902

§ 371 Date: Jun. 3, 2024

(51) Int. Cl. B23K 9/095; B23K 31/12

(52) U.S. Cl. CPC B23K 9/0953; B23K 31/125

(57) ABSTRACT

In order to attain an object of providing a technique to, upon detection of an abnormality in a welded part, provide notification of a factor of the detected abnormality, an abnormality diagnosis apparatus includes: an acquisition means (21) for acquiring time series data containing at least one of an electric current value and a voltage value at first welding; an abnormality determination means (22) for determining, with use of an abnormality determination model and based on the time series data acquired by the acquisition means, whether or not there is an abnormality in a welded part at the first welding; and an output means (23) for, if the abnormality determination means has determined that there is an abnormality, outputting the determination result and at least one of a factor of the abnormality and a remedial method for solving the abnormality.

### TECHNICAL FIELD

The present invention relates to an abnormality diagnosis apparatus, an abnormality diagnosis method, and a program which make it possible, when an abnormality in a welded part has been detected, to provide notification of a factor of the detected abnormality.

### BACKGROUND ART

As a method of joining steel sheets together, welding is known. For example, in order to confirm the strength of the joined steel sheets, nondestructive testing of the welded joint is carried out. As the nondestructive testing, radiographic testing, ultrasonic testing, and the like are widely used.

Patent Literature 1 discloses a technique in which a time series waveform of a welding voltage or a welding current detected from a welding power source is frequency-analyzed to generate frequency spectrum data, and a welding status is determined based on the frequency spectrum data.

Patent Literature 2 proposes a method in which, even in a case where a current waveform Xp in a welding process is locally apart from normal current waveforms W1 through Wn, it is possible to accurately determine an abnormality of the welding process.

### CITATION LIST

### Patent Literature

### Patent Literature 1

Japanese Patent Application Publication, No. 2018-144069

### Patent Literature 2

Japanese Patent Application Publication, No. 2019-118954

### SUMMARY OF INVENTION

### Technical Problem

However, in Patent Literature 1 and Patent Literature 1, even if it is possible to accurately find an abnormality, it is difficult to know a factor by which the abnormality of welding has occurred.

An example aspect of the present invention is accomplished in view of the above problem, and an example object thereof is to provide a technique which, in a case where an abnormality in a welded part has been detected, provides notification of a factor of the detected abnormality.

### Solution to Problem

An abnormality diagnosis apparatus in accordance with an example aspect of the present invention includes: an acquisition means for acquiring time series data that contains at least one selected from the group consisting of an electric current value and a voltage value at the time of first welding; an abnormality determination means for determining, with use of an abnormality determination model and based on the time series data which has been acquired by the acquisition means, whether or not there is an abnormality in a welded part at the time of the first welding, the abnormality determination model having learned a relation between (i) time series data containing at least one selected from the group consisting of an electric current value and a voltage value at the time of second welding and (ii) presence or absence of an abnormality in a welded part; and an output means for, in a case where the abnormality determination means has determined that there is an abnormality, outputting a result of the determination and at least one selected from the group consisting of a factor of the abnormality and a remedial method for solving the abnormality.

An abnormality diagnosis method in accordance with an example aspect of the present invention includes: acquiring time series data that contains at least one selected from the group consisting of an electric current value and a voltage value at the time of first welding; determining, with use of an abnormality determination model and based on the time series data which has been acquired, whether or not there is an abnormality in a welded part at the time of the first welding, the abnormality determination model having learned a relation between (i) time series data containing at least one selected from the group consisting of an electric current value and a voltage value at the time of second welding and (ii) presence or absence of an abnormality in a welded part; and in a case where it has been determined that there is an abnormality, outputting a result of the determination and at least one selected from the group consisting of a factor of the abnormality and a remedial method for solving the abnormality.

A program in accordance with an example aspect of the present invention causes a computer to function as an abnormality diagnosis apparatus including: an acquisition means for acquiring time series data that contains at least one selected from the group consisting of an electric current value and a voltage value at the time of first welding; an abnormality determination means for determining, with use of an abnormality determination model and based on the time series data which has been acquired by the acquisition means, whether or not there is an abnormality in a welded part at the time of the first welding, the abnormality determination model having learned a relation between (i) time series data containing at least one selected from the group consisting of an electric current value and a voltage value at the time of second welding and (ii) presence or absence of an abnormality in a welded part; and an output means for, in a case where the abnormality determination means has determined that there is an abnormality, outputting a result of the determination and at least one selected from the group consisting of a factor of the abnormality and a remedial method for solving the abnormality.

### Advantageous Effects of Invention

According to an example aspect of the present invention, it is possible to provide a technique which, when an abnormality in a welded part has been detected, provides notification of a factor of the detected abnormality.

### BRIEF DESCRIPTION OF DRAWINGS

FIG. 1 is a block diagram illustrating a configuration example of an abnormality diagnosis apparatus in accordance with a first example embodiment of the present invention.

FIG. 2 is a flowchart illustrating a flow of an abnormality diagnosis method in accordance with the first example embodiment of the present invention.

FIG. 3 is a block diagram illustrating a configuration example of a welding status diagnosis apparatus in accordance with a second example embodiment of the present invention.

FIG. 4 is a diagram for describing an example of welding using a welding machine.

FIG. 5 is a diagram illustrating an example of sensors incorporated in an electrode unit 101.

FIG. 6 is a diagram for describing an example of a shifted time series value.

FIG. 7 is a diagram for describing an abnormality of a weld bead which is formed in a welded part.

FIG. 8 is a flowchart for describing an example of a welding status diagnosis process.

FIG. 9 is a flowchart for describing a detailed example of a preprocessing.

FIG. 10 is a diagram for describing an example of abnormality information which is output by an output section 23.

FIG. 11 is a diagram illustrating another example of sensors incorporated in an electrode unit 101 in accordance with a fourth example embodiment of the present invention.

FIG. 12 is a block diagram illustrating a configuration example of a welding status diagnosis-training apparatus 10A in accordance with a fifth example embodiment of the present invention.

FIG. 13 is a flowchart for describing an example of a training process.

FIG. 14 is a block diagram illustrating an example of a computer which executes instructions of a program that is software for realizing functions.

### EXAMPLE EMBODIMENTS

### First Example Embodiment

The following description will discuss a first example embodiment of the present invention in detail, with reference to the drawings. The present example embodiment is a basic form of example embodiments described later.

### <Overview of Abnormality Diagnosis Apparatus 20>

An abnormality diagnosis apparatus 20 in accordance with the present example embodiment is, schematically speaking, an apparatus that diagnoses an abnormality of a welded part of a welding subject.

More specifically, the abnormality diagnosis apparatus 20 includes, for example: an acquisition means for acquiring time series data that contains at least one selected from the group consisting of an electric current value and a voltage value at the time of first welding; an abnormality determination means for determining, with use of an abnormality determination model and based on the time series data which has been acquired by the acquisition means, whether or not there is an abnormality in a welded part at the time of the first welding, the abnormality determination model having learned a relation between (i) time series data containing at least one selected from the group consisting of an electric current value and a voltage value at the time of second welding and (ii) presence or absence of an abnormality in a welded part; and an output means for, in a case where the abnormality determination means has determined that there is an abnormality, outputting a result of the determination and at least one selected from the group consisting of a factor of the abnormality and a remedial method for solving the abnormality.

### <Configuration of Abnormality Diagnosis Apparatus 20>

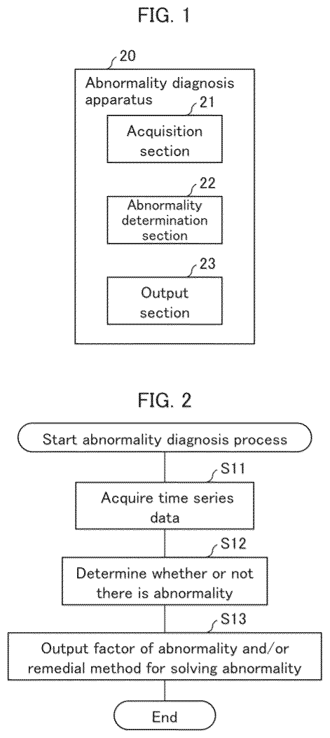

The following description will discuss a configuration of the abnormality diagnosis apparatus 20 in accordance with the present example embodiment, with reference to FIG. 1. FIG. 1 is a block diagram illustrating a configuration example of the abnormality diagnosis apparatus 20.

As illustrated in FIG. 1, the abnormality diagnosis apparatus 20 includes an acquisition section 21, an abnormality determination section 22, and an output section 23. The acquisition section 21 is configured to implement the acquisition means in the present example embodiment. The output section 23 is configured to implement the output means in the present example embodiment.

The acquisition section 21 acquires time series data containing at least one selected from the group consisting of an electric current value and a voltage value at the time of first welding.

The time of first welding is, for example, welding of a welding subject which is currently being carried out. For example, the welding subject is two steel sheets which are each sufficiently larger in size than the welding machine. The welding machine welds the steel sheets while moving above a joint part between the steel sheets.

The welding machine includes, for example, a plurality of sensors such as a position sensor, a velocity sensor, a current sensor, and a voltage sensor, and sensor values are output from the respective sensors. For example, the acquisition section 21 acquires, as time series data, sensor values output from the plurality of sensors at predetermined time intervals.

The abnormality determination section 22 determines, with use of an abnormality determination model and based on the time series data which has been acquired by the acquisition section 21, whether or not there is an abnormality in a welded part at the time of the first welding, the abnormality determination model having learned a relation between (i) time series data containing at least one selected from the group consisting of an electric current value and a voltage value at the time of second welding and (ii) presence or absence of an abnormality in a welded part.

The abnormality determination model is a model which is obtained by carrying out machine learning in advance while associating time series data at the time of second welding, which is welding of a welding subject carried out in the past, with presence or absence of an abnormality in a welded part. For example, the abnormality of the welded part is an abnormality of a weld bead which is formed in the welded part of steel sheets.

The abnormality determination model determines presence or absence of an abnormality of a welded part based on time series data which is obtained at the time of first welding.

In a case where the abnormality determination means has determined that there is an abnormality, the output section 23 outputs the determination result and at least one selected from the group consisting of a factor of the abnormality and a remedial method for solving the abnormality.

For example, in a case where the abnormality determination model has determined that there is an abnormality, the abnormality determination section 22 refers to correspondence information in which the determination result is associated with at least one selected from the group consisting of a factor of the abnormality and a remedial method for solving the abnormality. Then, the output section 23 outputs the determination result and at least one selected from the group consisting of the factor of the abnormality and the remedial method for solving the abnormality which is associated with the determination result.

Examples of the factor of the abnormality include: an excessively high or low velocity at which the welding machine moves; an excessively low electric current applied to the welded part; and the like. Examples of the remedial method for solving the abnormality include: adjustment of a moving velocity of the welding machine; adjustment of an electric current applied to the welded part; and the like.

The correspondence information is, for example, a table in which a determination result by the abnormality determination model is associated with a factor of the abnormality and/or a remedial method for solving the abnormality.

### <Example Advantage of Abnormality Diagnosis Apparatus 20>

According to the abnormality diagnosis apparatus in accordance with the present example embodiment, whether or not there is an abnormality in a welded part at the time of the first welding is determined based on the time series data at the time of first welding with use of the abnormality determination model which has learned a relation between (i) time series data at the time of second welding and (ii) presence or absence of an abnormality in a welded part. In a case where it has been determined that there is an abnormality, the determination result and at least one selected from the group consisting of a factor of the abnormality and a remedial method for solving the abnormality are output. Therefore, it is possible to diagnose an abnormality of a welded part without carrying out nondestructive testing or the like which is conventionally carried out, and it is thus possible to carry out abnormality diagnosis in real time and at low cost.

The output information includes at least one selected from the group consisting of a factor of the abnormality and a remedial method for solving the abnormality. Therefore, it is possible to reduce a time taken to analyze the factor of the abnormality and to consider the remedial method. As a result, it is possible to quickly complete the welding process.

### <Flow of Abnormality Diagnosis Method Carried Out by Abnormality Diagnosis Apparatus 20>

The following description will discuss a flow of an abnormality diagnosis method which is carried out by the abnormality diagnosis apparatus 20 configured as described above, with reference to FIG. 2. FIG. 2 is a flowchart illustrating the flow of the abnormality diagnosis method. As illustrated in FIG. 2, the abnormality diagnosis method includes step S11 and step S12.

In step S11, the acquisition section 21 acquires time series data containing at least one selected from the group consisting of an electric current value and a voltage value at the time of first welding.

In step S12, the abnormality determination section 22 determines, with use of an abnormality determination model and based on the time series data which has been acquired, whether or not there is an abnormality in a welded part at the time of the first welding, the abnormality determination model having learned a relation between (i) time series data containing at least one selected from the group consisting of an electric current value and a voltage value at the time of second welding and (ii) presence or absence of an abnormality in a welded part.

In step S13, in a case where it has been determined that there is an abnormality, the output section 23 outputs the determination result and at least one selected from the group consisting of a factor of the abnormality and a remedial method for solving the abnormality.

Thus, the abnormality diagnosis process is carried out.

### <Example Advantage of Information Processing Method>

According to the abnormality diagnosis method in accordance with the present example embodiment, whether or not there is an abnormality in a welded part at the time of the first welding is determined based on the time series data at the time of first welding with use of the abnormality determination model which has learned a relation between (i) time series data at the time of second welding and (ii) presence or absence of an abnormality in a welded part. In a case where it has been determined that there is an abnormality, the determination result and at least one selected from the group consisting of a factor of the abnormality and a remedial method for solving the abnormality are output. Therefore, it is possible to diagnose an abnormality of a welded part without carrying out nondestructive testing or the like which is conventionally carried out, and it is thus possible to carry out abnormality diagnosis in real time and at low cost.

In order to carry out conventional nondestructive testing, equipment for testing is needed, and as a result, costs are increased.

Moreover, in such nondestructive testing, only ranges of 1 m from respective of a start end side and a terminal end side of a welded joint are tested, regardless of a size and a length of steel sheets. Therefore, an abnormality of welding at the other positions could not be found.

Furthermore, the nondestructive testing is carried out by moving joined steel sheets to a testing field after the welding is completed. If an abnormality in welding is found by nondestructive testing, it is necessary to redo welding by returning the steel sheets to a welding field again. Therefore, reduction of time and energy taken to move steel sheets has been demanded.

The output information includes at least one selected from the group consisting of a factor of the abnormality and a remedial method for solving the abnormality. Therefore, it is possible to reduce a time taken to analyze the factor of the abnormality and to consider the remedial method. As a result, it is possible to quickly complete the welding process.

### Second Example Embodiment

The following description will discuss a second example embodiment of the present invention in detail with reference to the drawings. The same reference numerals are given to constituent elements which have functions identical with those described in the first example embodiment, and descriptions as to such constituent elements are omitted as appropriate.

### <Configuration of Welding Status Diagnosis Apparatus 10>

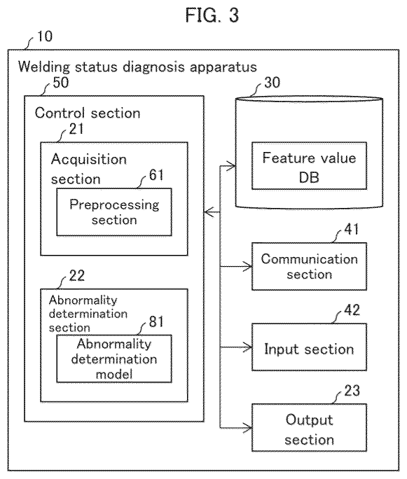

The following description will discuss a configuration of a welding status diagnosis apparatus 10 in accordance with the present example embodiment, with reference to FIG. 3.

FIG. 3 is a block diagram illustrating a configuration example of the welding status diagnosis apparatus 10. As illustrated in FIG. 3, the welding status diagnosis apparatus 10 includes a control section 50, a storage section 30, a communication section 41, an input section 42, and an output section 23.

The storage section 30 is constituted by, for example, a semiconductor memory device or the like, and stores data. The storage section 30 stores, for example, a feature value DB which will be described later. The storage section 30 also stores model parameters of an abnormality determination model 81.

The communication section 41 is an interface for connecting the welding status diagnosis apparatus 10 to a network. A specific configuration of the network does not limited the present example embodiment but, as an example, it is possible to employ a wireless local area network (LAN), a wired LAN, a wide area network (WAN), a public network, a mobile data communication network, or a combination of these networks.

The input section 42 receives various kinds of input to the welding status diagnosis apparatus 10. A specific configuration of the input section 42 does not limit the present example embodiment and, for example, the input section 42 may be configured to include an input device such as a keyboard, a touch pad, and the like. Alternatively, a configuration may be employed in which the input section 42 includes a data scanner that reads data via electromagnetic waves such as infrared rays or radio waves, a sensor for sensing an environmental condition, and the like.

The output section 23 is a functional block which has functions similar to those described in the first example embodiment, and which outputs a processing result by the welding status diagnosis apparatus 10. A specific configuration of the output section 23 does not limit the present example embodiment and, for example, the output section 23 is constituted by a display, a speaker, a printer, or the like, and displays various processing results by the welding status diagnosis apparatus 10 on a screen or outputs the various processing results as sounds or figures.

The output section 23 supplies information, which is to be output as needed, to the communication section 41 and provides the information to other apparatuses via a network.

The welding status diagnosis apparatus 10 is connected to a welding machine 100 (described later) by wired connection or wireless connection.

The control section 50 includes an acquisition section 21 and an abnormality determination section 22. In the example of FIG. 3, the acquisition section 21 includes a preprocessing section 61.

The preprocessing section 61 shifts, in the time direction, time series data which has been acquired from sensors provided for a plurality of electrodes included in the welding machine 100, and thus generates shifted time series data. Note that details of the generation of shifted time series data by the preprocessing section will be described later.

In the example of FIG. 3, the abnormality determination section 22 includes the abnormality determination model 81. The abnormality determination model 81 is a model which has learned a relation between (i) time series data at the time of second welding carried out in the past and (ii) presence or absence of an abnormality in a welded part. For example, a process is carried out in which time series data at the time of welding carried out in the past is accumulated, and the accumulated time series data is converted into feature values. Then, the feature values and labels each indicating presence or absence of an abnormality in a welded part are stored in association with each other.

For example, the feature value is binary data which is obtained by extracting (i) a feature pertaining to temporal change in time series data and (ii) a feature pertaining to a relation between sensor values, and combining the extracted features. Then, similarity between accumulated feature values and a newly obtained feature value is learned by machine learning.

With such machine learning, the abnormality determination model 81 can retrieve a feature value which is close to an input feature value from the feature values accumulated in advance. The abnormality determination model 81 can determine whether or not the input feature value represents an abnormality in a welded part by referring to a label given to the retrieved feature value.

That is, by inputting, into the abnormality determination model 81, shifted time series data at the time of first welding which is currently ongoing, abnormality information pertaining to whether or not there is an abnormality in a welded part is generated.

The abnormality determination model 81 converts the shifted time series data generated by the preprocessing section 61 into a feature value. At this time, the abnormality determination model 81, for example, extracts a plurality of sensor values at the same time from the shifted time series data, and generates partial time series data.

Then, the abnormality determination model 81 extracts features of temporal change of partial time series data and a relation between sensor values, and combines these features and converts the combined features into binary data. As such, the abnormality determination model 81 converts the shifted time series data into a feature value.

Note that shifted time series data may not be generated. In this case, the abnormality determination model 81 converts time series data into a feature value.

The abnormality determination model 81 compares the feature value obtained by the conversion with the feature values stored in the feature value DB which is stored in the storage section 30. The feature value DB stores, for example, feature values which have been obtained in welding processes carried out in the past by the welding machine 100.

Note that the feature values stored in the feature value DB are each given a label pertaining to an abnormality in a weld bead which is formed in a welded part of a welding subject in a welding process in which that feature value has been obtained. For example, a label indicating that the weld bead has been normally formed or a label indicating that formation of the weld bead is abnormal is given.

In a case where formation of the weld bead is abnormal, a type of the abnormality is also indicated by a label. Note that details of the type of abnormality will be described later.

The abnormality determination model 81 retrieves, from among the feature values stored in the feature value DB, a feature value which has been obtained at the time of first welding, and which is similar to a feature value obtained by converting shifted time series data.

In a case where the shifted time series data is not generated, the abnormality determination model 81 retrieves a feature value similar to a feature value which has been obtained by conversion.

Then, the abnormality determination model 81 refers to a label given to the retrieved feature value and generates information pertaining to whether or not there is an abnormality in a welded part at the time of first welding.

### <Example of Welding by Welding Machine>

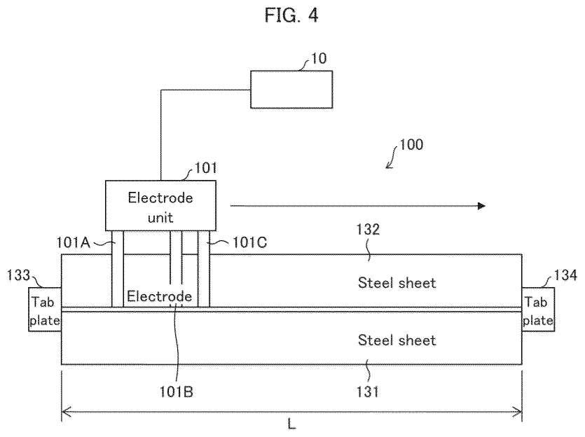

FIG. 4 is a diagram for describing an example of welding using the welding machine 100. Here, an example will be described in which welding of steel sheets is carried out with use of the welding machine 100 which carries out arc welding.

As illustrated in FIG. 4, the welding machine 100 welds a steel sheet 131 and a steel sheet 132 together. The steel sheet 131 and the steel sheet 132 before welding are fixed by a tab plate 133 and a tab plate 134 so as to make contact with each other.

The steel sheet 131 and the steel sheet 132 are each assumed to be a steel sheet having a length L. In this example, the steel sheet 131 and the steel sheet 132 are arranged so that edge surfaces thereof in the longitudinal direction make contact with each other, and the steel sheets are welded together in the longitudinal direction as a welded part.

The welding machine 100 is provided with an electrode unit 101, and the electrode unit 101 includes three electrodes, i.e., an electrode 101A, an electrode 101B, and an electrode 101C.

The length L of the steel sheet is sufficiently long as compared to the electrode unit 101. Therefore, the electrode unit 101 moves from left to right as indicated by the arrow in FIG. 4, and continues to weld the steel sheet 131 and the steel sheet 132 together. In this example, the electrode unit 101 carries out welding while moving along the longitudinal direction of the steel sheet 131 and the steel sheet 132.

A high voltage is applied to each of the electrodes, and thus a high-temperature arc is generated between (i) the welded part of the steel sheet 131 and the steel sheet 132 and (ii) each of the electrodes. Then, the electrodes, the steel sheet 131, and the steel sheet 132 are melted to form a weld bead.

The electrode unit 101 which moves above the steel sheets includes the electrode 101A, the electrode 101B, and the electrode 101C. Therefore, at a predetermined position in the welded part, the electrode 101C reaches first, the electrode 101A reaches next, and the electrode 101A reaches lastly. As such, the welding machine 100 is configured such that arcs are generated three times at the same position by the three electrodes so as to form a weld bead.

Welding by the welding machine 100 is carried out under control by a control section (not illustrated). For example, movement of the electrode unit 101, intensity of a voltage applied to each of the electrodes, and the like are controlled in accordance with a control procedure which is set in advance in the control section. As such, the welding process is automated by the welding machine 100.

In order for the control section to carry out control by the welding machine 100, sensors for detecting statuses of the electrode unit 101 and the electrodes are needed. For example, a sensor such as a position sensor for detecting a position of the electrode unit 101 which is moving is needed. Such a sensor is incorporated in manufacturing of the welding machine 100.

The welding status diagnosis apparatus 10 is, for example, connected to the welding machine 100 by wired connection or wireless connection so that communication with the control section can be carried out, and acquires sensor values output from sensors incorporated in the welding machine 100.

As such, the welding machine 100 includes the electrode unit 101 which moves above a welding subject and has a plurality of different electrodes for supplying welding currents to the welded part. The acquisition section 21 acquires, as time series data, sensor values which are output by the plurality of sensors in accordance with the movement of the electrode unit.

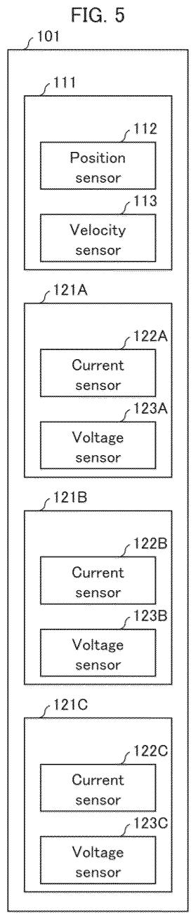

FIG. 5 is a diagram illustrating an example of sensors incorporated in the electrode unit 101. In this example, a sensor unit 111, a sensor unit 121A, a sensor unit 121B, and a sensor unit 121C are provided.

The sensor unit 111 is provided so as to correspond to the electrode unit 101. Meanwhile, the sensor unit 121A is provided so as to correspond to the electrode 101A, the sensor unit 121A is provided so as to correspond to the electrode 101B, and the sensor unit 121C is provided so as to correspond to the electrode 101C. Note that, in a case where it is not necessary to distinguish in particular, the sensor unit 121A, the sensor unit 121B, and the sensor unit 121C are collectively referred to as a sensor unit 121.

Each of the sensor units includes two sensors, and the acquisition section 21 acquires, as time series data, sensor values which are output by the respective sensors of the sensor units. That is, the time series data at the time of the first welding includes a plurality of pieces of time series data which include first time series data and second time series data and which are respectively acquired for the plurality of electrodes included in the welding machine.

As described above, the preprocessing section 61 shifts, in the time direction, time series data which has been acquired from the sensor unit provided for at least one electrode among the plurality of different electrodes. That is, time series data output from at least one sensor unit among the sensor units 121A through 121C is shifted in the time direction with respect to time series data output from the sensor unit 111.

As such, the preprocessing section 61 relatively shifts, in the time direction, the first time series data and the second time series data in the time series data at the time of first welding, and thus generates shifted time series data at the time of first welding.

Then, the abnormality determination model 81 determines whether or not there is an abnormality in the welded part at the time of first welding while using the shifted time series data as input.

As described above, the welding machine 100 is configured such that arcs are generated three times at the same position by the three electrodes so as to form a weld bead.

For example, in accordance with the movement of the electrode unit 101, the electrode 101C reaches a position (referred to as a central position) corresponding to a length L/2 of the steel sheets 131 and 132 at a time t which is a time at which a predetermined time has elapsed from when the electrode unit 101 started moving. Then, when a time b has elapsed to be a time t+b, the electrode 101B reaches the central position. Furthermore, when a time a has elapsed from the time t to be a time t+a(a>b), the electrode 101A reaches the central position.

As such, a weld bead at the central position is formed by an arc generated by the electrode 101C at the time t, an arc generated by the electrode 101B at the time t+b, and an arc generated by the electrode 101A at the time t+a. Therefore, in order to diagnose an abnormality in the weld bead at the central position, it is necessary to shift, in the time direction, pieces of time series data of the sensor values for the electrode 101B and the electrode 101A.

That is, it is necessary to shift, by the time b, time series data obtained from the sensors included in the sensor unit 121B corresponding to the electrode 101B, and it is necessary to shift, by the time a, time series data obtained from the sensors included in the sensor unit 121A corresponding to the electrode 101A. Here, the time b and the time a are determined according to distances between the electrodes and a velocity at which the electrode unit 101 moves.

Note that a velocity at which the electrode unit 101 moves can be, for example, identified based on a sensor value output by a velocity sensor 113 (later described).

Therefore, the preprocessing section 61 generates shifted time series data in which, among pieces of time series data of sensor values of the sensor unit 111 and the sensor units 121, time series data of sensor values of the sensor unit 121B and time series data of sensor values of the sensor unit 121A are shifted.

That is, the acquisition section 21 further acquires velocity information indicating a velocity at the time of first welding, and relatively shifts the first time series data and the second time series data in the time direction in accordance with the velocity indicated by the velocity information.

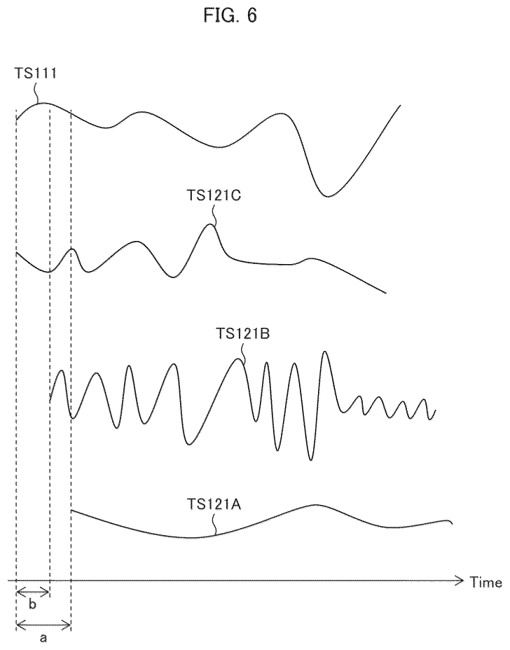

FIG. 6 is a diagram for describing an example of shifted time series data. In FIG. 6, the horizontal axis indicates time and the vertical axis indicates sensor values, and time series data of sensor values (i.e., change in the sensor values over time) is indicated by a waveform.

In this example, the following waveforms are indicated: a waveform TS111 of time series data of sensor values of the sensor unit 111; a waveform TS121C of time series data of sensor values of the sensor unit 121C; a waveform TS121B of time series data of sensor values of the sensor unit 121B; and a waveform TS121A of time series data of sensor values of the sensor unit 121A.

Note that, in an actual case, a plurality of sensors can be included in each of the sensor unit 111, the sensor unit 121A, the sensor unit 121B, and the sensor unit 121C. Therefore, each of the sensor units can output pieces of time series data of a plurality of sensor values. However, in order to simplify the description, here, it is assumed that each of the sensor units outputs one piece of time series data.

As illustrated in FIG. 6, a start position of the waveform TS121B of the time series data is delayed by the time b from a start position of the waveform TS111 of the time series data and the waveform TS121C of the time series data. Moreover, a start position of the waveform TS121A of the time series data is delayed by the time a from a start position of the waveform TS111 of the time series data and the waveform TS121C of the time series data.

With the above configuration, it is possible to obtain time series data of a case in which as if the three electrodes have reached the central position at the time t.

In this example, with respect to the time series data output from the sensor unit 121C, the time series data output from the sensor unit 121A and the time series data output from the sensor unit 121B are delayed. However, for example, it is possible that, with respect to the time series data output from the sensor unit 121B, the time series data output from the sensor unit 121C is advanced in the time direction, and the time series data output from the sensor unit 121A is delayed. Alternatively, it is possible that, with respect to the time series data output from the sensor unit 121A, the time series data output from the sensor unit 121B and the time series data output from the sensor unit 121C are advanced in the time direction.

Here, an example has been described in which the electrode unit 101 is provided with the sensor unit 121A, the sensor unit 121B, and the sensor unit 121C. However, for example, only one of the sensor unit 121A, the sensor unit 121B, and the sensor unit 121C may be provided in the electrode unit 101. In such a case, it is not necessary to shift time series data.

Retuning to FIG. 5, the following description will further discuss an example of sensors incorporated in the electrode unit 101.

The sensor unit 111 is one sensor unit which is provided for the electrode unit 101 and includes a position sensor 112 and a velocity sensor 113. The position sensor 112 is a sensor that detects a position of the electrode unit 101. The velocity sensor 113 is a sensor that detects a velocity at which the electrode unit 101 moves.

For example, the position sensor 112 detects, with a default position of the electrode unit 101 as the origin, how much the electrode unit 101 has moved in the X-axis, Y-axis, and Z-axis directions, and outputs the detected value as a sensor value. The default position is, for example, a position of the electrode unit 101 before execution of the welding process starts.

The velocity sensor 113 detects a velocity at which the electrode unit 101 moves. For example, the velocity sensor 113 detects a moving velocity of the electrode unit based on the number of revolutions of a motor which drives a moving mechanism for moving the electrode unit 101 along the longitudinal direction of the steel sheet 131 and the steel sheet 132. The velocity sensor 113 outputs the detected velocity as a sensor value.

The sensor units 121 are sensor units which are provided for the respective electrodes. The sensor unit 121A includes a current sensor 122A that detects an electric current value output by the electrode 101A when generating an arc, and a voltage sensor 123A that detects a voltage value applied to the electrode 101A.

Similarly, the sensor unit 121B includes a current sensor 122B and a voltage sensor 123B, and the sensor unit 121C includes a current sensor 122C and a voltage sensor 123C.

Note that, in a case where it is not necessary to distinguish between the current sensor 122A through the current sensor 122C, the current sensors are simply referred to as current sensors 122. In a case where it is not necessary to distinguish between the voltage sensor 123A through the voltage sensor 123C, the voltage sensors are simply referred to as voltage sensors 123.

Here, an example has been described in which the sensor units are incorporated in the electrode unit 101. Note, however, that, for example, some of or all of the sensor units may be incorporated in the control section of the welding machine 100. That is, it is only necessary that the sensor units illustrated in FIG. 5 are incorporated in the welding machine 100.

FIG. 5 illustrates an example of the sensors included in the sensor units. Note, however, that a sensor(s) other than those sensors may be included.

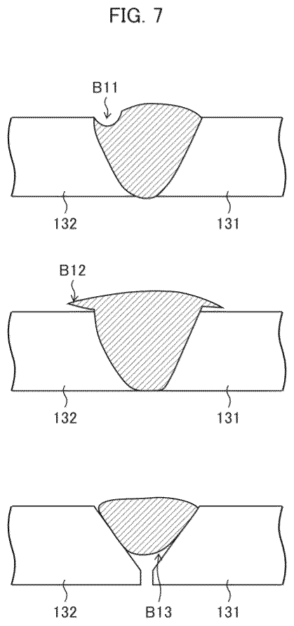

FIG. 7 is a diagram for describing an abnormality of a weld bead which is formed in a welded part. As described above, the weld bead is formed between the steel sheet 131 and the steel sheet 132 by melting the steel sheet 131 and the steel sheet 132. FIG. 7 illustrates three examples of an abnormality in a weld bead.

The weld bead illustrated in the upper part of FIG. 7 has an edge part B11 that is dented at the upper side thereof. The weld bead having a dented upper edge part is called an undercut, and is often formed when the welding velocity is excessively high. This is because, if the welding velocity is excessively high, an amount of deposited metal is prone to insufficiency.

The weld bead illustrated in the middle part of FIG. 7 has an upper edge part B12 that overflows from the welded part between the steel sheet 131 and the steel sheet 132. As such, the weld bead in which the upper edge part thereof overflows from the welded part is called an overlap, and is often formed when the welding velocity is excessively low. This is because, if the welding velocity is excessively low, an amount of deposited metal becomes excessively large.

The weld bead illustrated in the lower part of FIG. 7 has a lower edge part B13 that does not reach a bottom part which is a lower edge of the welded part between the steel sheet 131 and the steel sheet 132. As such, the weld bead whose lower edge part does not reach the bottom part of the welded part is called an incomplete penetration, and is often formed when an electric current value output by an electrode is excessively low. This is because, if the electric current value output by the electrode is excessively low, an arc is weakened, and a deposited metal does not sufficiently melt.

The plurality of feature values accumulated in advance in the feature value DB are each given a label indicating an undercut in which an edge part of a weld bead is dented, an overlap in which an edge of a weld bead is formed outside a welded part, or an incomplete penetration in which a weld bead is not formed at the bottom part of a welded part.

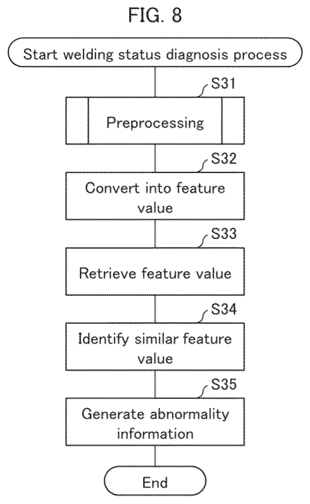

Next, an example of a welding status diagnosis process carried out by the welding status diagnosis apparatus 10 of the present example embodiment will be described with reference to a flowchart of FIG. 8.

In step S31, the preprocessing section 61 carries out a preprocessing. Thus, as described above, shifted time series data is generated by shifting the time series data acquired from the sensor unit in the time direction in accordance with the velocity at which the electrode unit 101 moves.

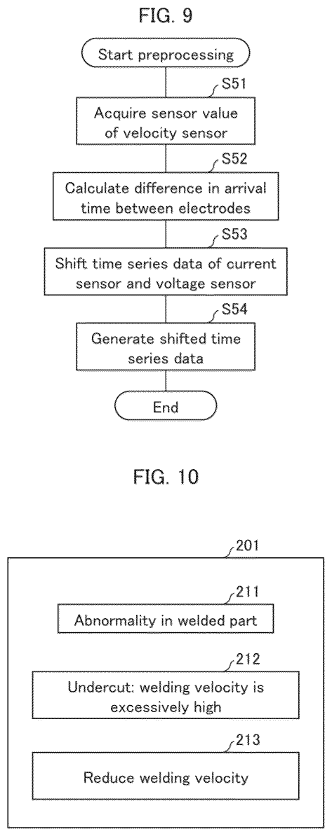

Here, details of the preprocessing of step S31 will be described with reference to a flowchart of FIG. 9.

In step S51, the preprocessing section 61 acquires a sensor value of the velocity sensor 113 of the sensor unit 111 and identifies a velocity at which the electrode unit moves.

In step S52, the preprocessing section 61 calculates a difference in time at which the electrodes reach the same position of a welded part. At this time, for example, as described above, a degree to which each of the electrode 101B and the electrode 101A is delayed from the electrode 101C to reach the central position is calculated. Note that the distances between the electrodes are assumed to have been notified to the preprocessing section 61 in advance.

In step S53, the preprocessing section 61 shifts, in the time direction, time series data of sensor values output from the current sensor 122 and the voltage sensor 123.

In this case, for example, as described above with reference to FIG. 6, time series data of the sensor values output from the current sensor 122B and the voltage sensor 123B included in the sensor unit 121B is shifted by the time b. Moreover, time series data of the sensor values output from the current sensor 122A and the voltage sensor 123A included in the sensor unit 121A is shifted by the time a.

In step S54, the preprocessing section 61 generates shifted time series data.

Thus, the preprocessing is carried out.

Returning to FIG. 8, the descriptions continue. After the process of step S31, in step S32, the abnormality determination model 81 converts the shifted time series data generated by the preprocessing section 61 into a feature value.

In step S33, the abnormality determination model 81 retrieves, from the feature values stored in the feature value DB, a feature value similar to the feature value which has been obtained by the process of step S32.

In step S34, the abnormality determination model 81 identifies, from the feature values stored in the feature value DB as a retrieval result of the process of step S33, a feature value similar to the feature value which has been obtained by the process of step S32.

In step S35, the abnormality determination model 81 generates abnormality information with reference to a label given to the feature value which has been identified in the process of step S34. That is, an abnormality of the weld bead formed in the welded part and a type of the abnormality are detected from the feature value which is obtained in the currently ongoing welding process.

As described above, the feature values stored in the feature value DB are each given a label pertaining to an abnormality of a weld bead which is formed in a welded part of a welding subject in a welding process in which that feature value has been obtained. For example, it is possible to include, in the abnormality information, information indicating whether or not the weld bead is abnormal and information indicating a factor of the abnormality.

For example, in a case where a label given to a feature value which has been identified in the process of step S34 and which is similar to the feature value of time series data in the ongoing welding process indicates an undercut, a factor of the abnormality is that “welding velocity is excessively high”.

For example, in a case where a label given to a feature value which is similar to the feature value of time series data in the ongoing welding process indicates an overlap, a factor of the abnormality is that “welding velocity is excessively low”.

Alternatively, in a case where a label given to the feature value similar to the feature value of time series data in the ongoing welding process indicates an incomplete penetration, a factor of the abnormality is that “electric current value output by electrode is excessively low”.

As such, it is possible to identify a factor of an abnormality based on a label given to a feature value. Therefore, the abnormality information can include information indicating an abnormality of a weld bead and information indicating a factor of the abnormality.

Furthermore, the abnormality information may include a remedial method based on the factor of the abnormality.

For example, in a case where a label given to a feature value which is similar to the feature value of time series data in the ongoing welding process indicates an undercut, a remedial method is to “reduce moving velocity of electrode unit 101”.

For example, in a case where a label given to a feature value which is similar to the feature value of time series data in the ongoing welding process indicates an overlap, a remedial method is to “increase moving velocity of electrode unit 101”.

Alternatively, in a case where a label given to the feature value similar to the feature value of time series data in the ongoing welding process indicates an incomplete penetration, a remedial method is to “increase electric current applied to electrode of electrode unit 101”.

As such, the abnormality information can include a remedial method for solving the abnormality of the weld bead.

The output section 23 outputs, as information pertaining to whether or not there is an abnormality, the abnormality information generated in the process of step S35. That is, the welding status diagnosis apparatus 10 outputs, together with information indicating whether or not a weld bead formed in a welded part of steel sheets is abnormal, abnormality information including at least one selected from the group consisting of a factor of the abnormality and a remedial method for solving the abnormality.

For example, abnormality information is generated by referring to a table which is stored in advance in the storage section 30 and in which a determination result by the abnormality determination model is associated with an abnormality factor and/or a remedial method.

For example, a table as described below is stored in the storage section 30.

### Determination Results

0: Normal
1: Abnormal, factor “undercut”, remedial method “reduce welding velocity”
2: Abnormal, factor “overlap”, remedial method “increase welding velocity”
2: Abnormal, factor “incomplete penetration”, remedial method “increase electric current value”

With reference to such a table, together with information indicating whether or not the weld bead is abnormal, abnormality information including at least one selected from the group consisting of a factor of the abnormality and a remedial method for solving the abnormality is generated and output.

FIG. 10 is a diagram for describing an example of abnormality information which is output by an output section 23. In this example, abnormality information is displayed on a display apparatus 201 of the output section 23.

In FIG. 10, an abnormality presence display region 211, which displays presence or absence of an abnormality, displays “abnormality in welded part” on the display apparatus 201 so as to indicate that there is an abnormality in the welded part. An abnormality factor display region 212 for displaying a factor of the abnormality on the display apparatus 201 indicates “undercut: welding velocity is excessively high” as a factor of the abnormality. A remedial method display region 213 for displaying a remedial method for solving the abnormality on the display apparatus 201 displays “reduce welding velocity”.

Note that the abnormality factor display region 212 may display “welding velocity is excessively high” or may display “undercut”. As described above with reference to FIG. 7, by identifying a type of abnormality in a weld bead formed in a welded part, it is possible to identify a factor of the abnormality. Therefore, the type of the abnormality in the weld bead may be displayed as a factor of the abnormality.

That is, the information pertaining to whether or not there is an abnormality may include information indicating at least one selected from the group consisting of an undercut, an overlap, and an incomplete penetration.

It may be possible that the display apparatus 201 displays the abnormality presence display region 211 and the abnormality factor display region 212, but does not display the remedial method display region 213. Alternatively, it may be possible that the display apparatus 201 displays the abnormality presence display region 211 and the remedial method display region 213, but does not display the abnormality factor display region 212.

With the above configuration, it is possible to reduce a time taken to analyze the factor of the abnormality and to consider the remedial method. As a result, it is possible to quickly complete the welding process. Moreover, it is possible to diagnose an abnormality of a welded part without carrying out nondestructive testing or the like which is conventionally carried out, and it is thus possible to carry out abnormality diagnosis in real time and at low cost.

### Third Example Embodiment

The following description will discuss a third example embodiment of the present invention in detail, with reference to drawings. The same reference numerals are given to constituent elements which have functions identical with those described in the second example embodiment, and descriptions as to such constituent elements are omitted as appropriate.

The output section 23 may further output control information for causing the welding machine 100 to carry out a remedial method based on a factor of an abnormality included in abnormality information. The control information is, for example, supplied to the control section of the welding machine 100 via the communication section 41.

For example, in a case where the factor of the abnormality is “undercut”, control information for reducing the welding velocity is output.

For example, in a case where the factor of the abnormality is “overlap”, control information for increasing the welding velocity is output.

For example, in a case where the factor of the abnormality is “incomplete penetration”, control information for increasing an electric current value output by the electrode is output.

With this configuration, in a case where the welding status diagnosis apparatus 10 has detected an abnormality in a weld bead, control information including a remedial method for solving the abnormality can be automatically supplied to the welding machine 100. For example, in a case where a label given to a feature value similar to a feature value of time series data in the ongoing welding process indicates an undercut, control information for reducing the moving velocity of the electrode unit 101 can be generated and supplied to the control section of the welding machine 100.

Thus, in a case where the welding status diagnosis apparatus 10 has detected an abnormality in a weld bead, a remedial method for solving the detected abnormality can be reflected in the welding process which is being carried out by the welding machine 100. Therefore, it is possible to further reduce a time taken to deal with the abnormality.

### Fourth Example Embodiment

The following description will discuss a fourth example embodiment of the present invention in detail with reference to the drawings. The same reference numerals are given to constituent elements which have functions identical with those described in the second example embodiment, and descriptions as to such constituent elements are omitted as appropriate.

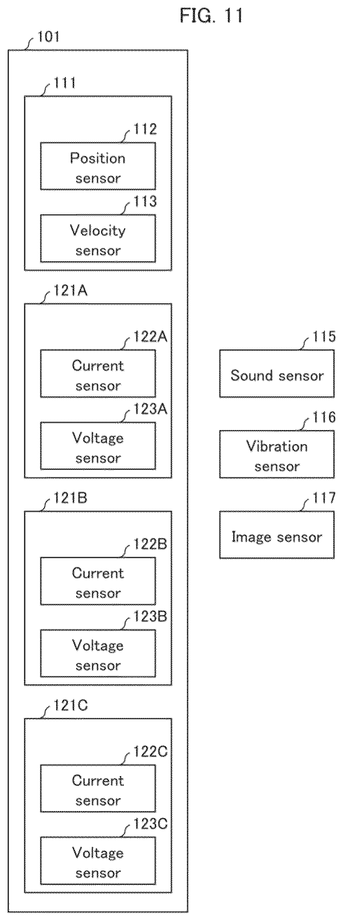

FIG. 11 is a diagram illustrating another example of sensors incorporated in the electrode unit 101. In this example, a sound sensor 115, a vibration sensor 116, and an image sensor 117 are provided in addition to the example described above with reference to FIG. 5. The other sensors are similar to the example described above with reference to FIG. 5.

The sound sensor 115 detects sound of an ongoing welding process and outputs a sensor value. The vibration sensor 116 detects vibration due to the ongoing welding process and outputs a sensor value. The image sensor 117 captures an X-ray image of the welded part. The image sensor 117, for example, outputs a sensor value corresponding to pixels of the captured image.

Note that it is not necessary that all of the sound sensor 115, the vibration sensor 116, and the image sensor 117 are provided, and it is only necessary that at least one selected from the group consisting of these sensors is provided.

That is, in the present example embodiment, at least one selected from the sound sensor 115 that detects sound of the ongoing welding process, the vibration sensor 116 that detects vibration due to the ongoing welding process, and the image sensor 117 that captures an X-ray image of the welded part is further included.

By including time series data of sensor values output from such sensors in a feature value, it is possible to more accurately detect an abnormality in the weld bead.

Here, an example has been described in which the sensor units are incorporated in the electrode unit 101. Note, however, that, for example, some of or all of the sensor units may be incorporated in the control section of the welding machine 100. That is, it is only necessary that the sensor units illustrated in FIG. 10 are incorporated in the welding machine 100.

### Fifth Example Embodiment

The following description will discuss a fifth example embodiment of the present invention in detail with reference to the drawings. The same reference numerals are given to constituent elements which have functions identical with those described in the second example embodiment, the third example embodiment, or the fourth example embodiment, and descriptions as to such constituent elements are omitted as appropriate.

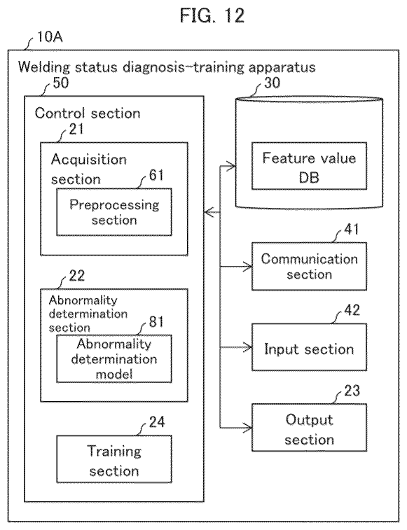

FIG. 12 is a block diagram illustrating a configuration example of a welding status diagnosis-training apparatus 10A in accordance with the present example embodiment. The welding status diagnosis-training apparatus 10A in accordance with the present example embodiment carries out training of the abnormality determination model 81, in addition to the welding status diagnosis process.

The welding status diagnosis-training apparatus 10A in accordance with the present example embodiment is different from the welding status diagnosis apparatus 10 described above with reference to FIG. 3 in that a training section 24 is provided in the abnormality diagnosis apparatus 20. Configurations other than the training section 24 of the welding status diagnosis-training apparatus 10A are similar to those described above with reference to FIG. 3.

The training section 24 converts time series data obtained from a welding process at the time of second welding into a feature value and causes the storage section 30 to store the feature value with a label pertaining to an abnormality in a weld bead, and thus generates a feature value DB.

For example, when the welding machine 100 has carried out welding of steel sheets, time series data of sensor values output from the sensors atached to the welding machine 100 is acquired by the acquisition section 21. For example, the acquisition section 21 generates shifted time series data as described above with reference to FIG. 9.

That is, the acquisition section 21 acquires time series data containing at least one selected from the group consisting of an electric current value and a voltage value at the time of second welding.

The time series data output from the acquisition section 21 is supplied to the abnormality determination section 22. As described above, the abnormality determination section 22 converts the shifted time series data into a feature value using the abnormality determination model 81. The converted feature value is supplied to the training section 24.

For example, after welding of the steel sheets by the welding machine 100 is completed, an abnormality in a weld bead formed in a welded part of the steel sheets is tested by an operator of the welding machine, a tester who carries out testing of welding, or the like. In a case where an abnormality of the weld bead has been found by testing, information indicating the abnormality of the weld bead and a type of the abnormality (e.g., undercut, overlap, incomplete penetration, or the like) is input by the operator, the tester, or the like via the input section 42.

The welding process of welding the steel sheets by the welding machine 100 is carried out multiple times, and in each of the welding processes carried out, an abnormality in a weld bead is tested.

The training section 24 gives, to a feature value that corresponds to a welding process for which information indicating an abnormality of a weld bead and a type of the abnormality has been input, a label pertaining to the abnormality of the weld bead. For example, in a case where a label indicating that formation of a weld bead is abnormal is given, and formation of the weld bead is abnormal, a type of the abnormality is also indicated by a label.

The training section 24 gives a label indicating that the weld bead has been normally formed to a feature value that corresponds to a welding process for which information indicating an abnormality in a weld bead and a type of the abnormality has not been input.

As such, the training section 24 generates the feature value DB by storing, with labels, feature values obtained from welding processes carried out by the welding machine 100. Note that data including shifted time series data obtained from a welding process at the time of second welding, feature values, and labels is also referred to as training data.

### (Example of Training Process Carried Out by Training Section 24)

The following description will discuss an example of a training process carried out by the training section 24 using the feature value DB.

First, the training section 24 randomly selects one piece of shifted time series data from the training data. In the following description, for convenience, the selected data is sometimes referred to as a piece of shifted time series data D1.

Next, the training section 24 selects, as verification data, other pieces of shifted time series data. The selected pieces of data are sometimes referred to as pieces of shifted time series data D2, D3, D4, and the like, for convenience. The training section 24 converts each piece of data into a feature value (binary data) by using the abnormality determination model 81 of the abnormality determination section 22.

Then, the training section 24 refers to a label given to the piece of shifted time series data D1 and labels given to the respective pieces of shifted time series data D2, D3, and D4, and updates parameters of the abnormality determination model 81 so that, among the pieces of shifted time series data D2, D3, and D4, a feature value of a piece of shifted time series data given with a label identical with the label given to the piece of shifted time series data D1 becomes closer to the feature value of the piece of shifted time series data D1.

Here, it is possible to use a degree of similarity of the feature value as an index of training by the training section 24. More specifically, an ordinal number pertaining to feature values may be used as an index pertaining to the degree of similarity. In a case where the ordinal number is used, for example, the ordinal number can be indexed by using a sigmoid function or the like.

As such, the acquisition section 21 acquires training data including a label and time series data containing at least one selected from the group consisting of an electric current value and a voltage value at the time of second welding, and the training section 24 trains the abnormality determination model 81 using the training data.

After the feature value DB in which a sufficiently large number of feature values are stored has been generated, it is possible to carry out the welding diagnosis process by the welding status diagnosis-training apparatus 10A with use of the abnormality determination model 81 which has been trained as described above. That is, in the welding diagnosis process, the abnormality determination model 81 retrieves a similar feature value from the plurality of feature values stored in the feature value DB.

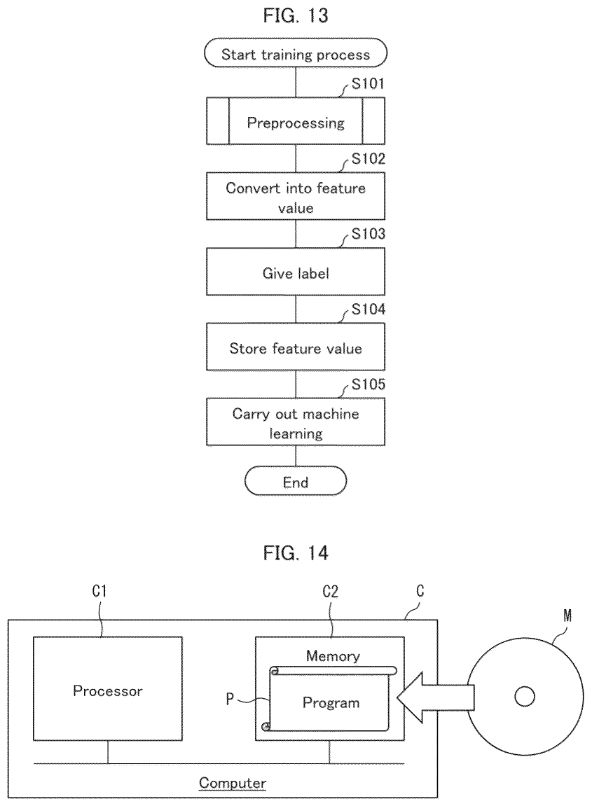

Next, an example of a training process which is carried out by the welding status diagnosis-training apparatus 10A of FIG. 12 will be described with reference to the flowchart of FIG. 13.

In step S101, the preprocessing section 61 of the time series data acquisition carries section 21 out a preprocessing. This process is similar to the process described with reference to FIG. 9, and thus a detailed description thereof is omitted. Thus, shifted time series data is generated.

In step S102, the abnormality determination section 22 converts the shifted time series data generated in the process of step S101 into a feature value.

In step S103, the training section 24 gives a label to the feature value which has been converted in the process of step S102. As described above, the label is given based on information indicating an abnormality of a weld bead and a type of the abnormality which have been input via the input section 42.

In step S104, the training section 24 stores in the storage section 30 the feature value to which the label has been given in the process of step S103.

Note that the welding process is carried out a plurality of times, and the database generation process is carried out each time the welding process is carried out. As such, the plurality of feature values are stored with labels, and thus the feature value DB is generated.

In step S105, the training section 24 carries out machine learning. At this time, as described above, the training section 24 updates parameters of the abnormality determination model 81. That is, the training section 24 updates parameters of the abnormality determination model 81 so that, among the pieces of shifted time series data D2, D3, and D4, a feature value of a piece of shifted time series data given with a label identical with the label given to the piece of shifted time series data D1 becomes closer to the feature value of the piece of shifted time series data D1.

Thus, the training process is carried out.

As such, according to the welding status diagnosis-training apparatus 10A, it is possible to suitably train the abnormality determination model 81.

### [Software Implementation Example]

Some or all of the functions of the abnormality diagnosis apparatus 20, the welding status diagnosis apparatus 10, and the welding status diagnosis-training apparatus 10A may be implemented by hardware such as an integrated circuit (IC chip), or may be implemented by software.

In the latter case, each of the abnormality diagnosis apparatus 20, the welding status diagnosis apparatus 10, and the welding status diagnosis-training apparatus 10A is realized by, for example, a computer that executes instructions of a program that is software realizing the foregoing functions. FIG. 14 illustrates an example of such a computer (hereinafter, referred to as “computer C”).

The computer C includes at least one processor C1 and at least one memory C2. The memory C2 stores a program P for causing the computer C to function as the abnormality diagnosis apparatus 20, the welding status diagnosis apparatus 10, and the welding status diagnosis-training apparatus 10A. In the computer C, the processor C1 reads the program P from the memory C2 and executes the program P, so that the functions of the abnormality diagnosis apparatus 20, the welding status diagnosis apparatus 10, and the welding status diagnosis-training apparatus 10A are realized.

Examples of the processor C1 include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some or all of the foregoing example embodiments can also be described as below. Note, however, that the present invention is not limited to the following supplementary notes.

### Supplementary Note 1

An abnormality diagnosis apparatus, including: an acquisition means for acquiring time series data that contains at least one selected from the group consisting of an electric current value and a voltage value at the time of first welding; an abnormality determination means for determining, with use of an abnormality determination model and based on the time series data which has been acquired by the acquisition means, whether or not there is an abnormality in a welded part at the time of the first welding, the abnormality determination model having learned a relation between (i) time series data containing at least one selected from the group consisting of an electric current value and a voltage value at the time of second welding and (ii) presence or absence of an abnormality in a welded part; and an output means for, in a case where the abnormality determination means has determined that there is an abnormality, outputting a result of the determination and at least one selected from the group consisting of a factor of the abnormality and a remedial method for solving the abnormality.

### Supplementary Note 2

The abnormality diagnosis apparatus according to supplementary note 1, in which: the abnormality determination model used by the abnormality determination means converts time series data into a feature value, retrieves, from among a plurality of feature values accumulated in advance, a feature value similar to the feature value obtained by converting the time series data, and generates, with reference to a label given to the feature value which has been retrieved, information pertaining to whether or not there is an abnormality in a welded part at the time of the first welding.

### Supplementary Note 3

The abnormality diagnosis apparatus according to supplementary note 2, in which: the information pertaining to whether or not there is an abnormality includes information indicating at least one selected from the group consisting of an undercut in which an edge part of a weld bead is dented, an overlap in which an edge part of a weld bead is formed outside the welded part, and an incomplete penetration in which a weld bead is not formed at a bottom part of the welded part.

### Supplementary Note 4

The abnormality diagnosis apparatus, according to any one of supplementary notes 1 through 3, in which: the acquisition means acquires training data containing a label and time series data which contains at least one selected from the group consisting of an electric current value and a voltage value at the time of the second welding; and the abnormality diagnosis apparatus further includes a training means for training the abnormality determination model with use of the training data.

### Supplementary Note 5

The abnormality diagnosis apparatus according to any one of supplementary notes 1 through 4, in which: the output means further outputs, at the time of the first welding, control information corresponding to a remedial method for solving an abnormality of the welded part.

### Supplementary Note 6

The time series data at the time of the first welding includes a plurality of pieces of time series data which include first time series data and second time series data and which are respectively acquired for a plurality of electrodes included in a welding machine.

### Supplementary Note 7

The abnormality diagnosis apparatus according to supplementary note 6, in which: the acquisition means generates shifted time series data at the time of the first welding by relatively shifting, in a time direction, the first time series data and the second time series data in the time series data at the time of the first welding; and the abnormality determination means determines, based on the shifted time series data, whether or not there is an abnormality in the welded part at the time of the first welding.

### Supplementary Note 8

The abnormality diagnosis apparatus according to supplementary note 7, in which: the acquisition means further acquires velocity information indicating a velocity at the time of the first welding; and the acquisition means relatively shifts the first time series data and the second time series data in the time direction in accordance with the velocity indicated by the velocity information.

### Supplementary Note 9

An abnormality diagnosis method, including: acquiring time series data that contains at least one selected from the group consisting of an electric current value and a voltage value at the time of first welding; determining, with use of an abnormality determination model and based on the time series data which has been acquired, whether or not there is an abnormality in a welded part at the time of the first welding, the abnormality determination model having learned a relation between (i) time series data containing at least one selected from the group consisting of an electric current value and a voltage value at the time of second welding and (ii) presence or absence of an abnormality in a welded part; and in a case where it has been determined that there is an abnormality, outputting a result of the determination and at least one selected from the group consisting of a factor of the abnormality and a remedial method for solving the abnormality.

### Supplementary Note 10

A program for causing a computer to function as an abnormality diagnosis apparatus including: an acquisition means for acquiring time series data that contains at least one selected from the group consisting of an electric current value and a voltage value at the time of first welding; an abnormality determination means for determining, with use of an abnormality determination model and based on the time series data which has been acquired by the acquisition means, whether or not there is an abnormality in a welded part at the time of the first welding, the abnormality determination model having learned a relation between (i) time series data containing at least one selected from the group consisting of an electric current value and a voltage value at the time of second welding and (ii) presence or absence of an abnormality in a welded part; and an output means for, in a case where the abnormality determination means has determined that there is an abnormality, outputting a result of the determination and at least one selected from the group consisting of a factor of the abnormality and a remedial method for solving the abnormality.

### Additional Remark 3

Furthermore, some of or all of the foregoing example embodiments can also be expressed as below.

An abnormality diagnosis apparatus including at least one processor, the at least one processor carrying out: an acquisition process of acquiring time series data that contains at least one selected from the group consisting of an electric current value and a voltage value at the time of first welding; an abnormality determination process of determining, with use of an abnormality determination model and based on the time series data which has been acquired in the acquisition process, whether or not there is an abnormality in a welded part at the time of the first welding, the abnormality determination model having learned a relation between (i) time series data containing at least one selected from the group consisting of an electric current value and a voltage value at the time of second welding and (ii) presence or absence of an abnormality in a welded part; and an output process of, in a case where it has been determined in the abnormality determination process that there is an abnormality, outputting a result of the determination and at least one selected from the group consisting of a factor of the abnormality and a remedial method for solving the abnormality.

Note that the abnormality diagnosis apparatus can further include a memory. The memory can store a program for causing the at least one processor to carry out the time series value acquisition process and the abnormality method output process. The program can be stored in a computer-readable non-transitory tangible storage medium.

### REFERENCE SIGNS LIST

10: Welding status diagnosis apparatus
20: Abnormality diagnosis apparatus
21: Acquisition section
22: Abnormality determination section
23: Output section
30: Storage section
41: Communication section
42: Input section
61: Preprocessing section
81: Abnormality determination model

What is claimed is:

1. An abnormality diagnosis apparatus, comprising at least one processor, the at least one processor carrying out:
an acquisition process of acquiring time series data that contains at least one selected from the group consisting of an electric current value and a voltage value at the time of first welding;
an abnormality determination process of determining, with use of an abnormality determination model and based on the time series data which has been acquired in the acquisition process, whether or not there is an abnormality in a welded part at the time of the first welding, the abnormality determination model having learned a relation between (i) time series data containing at least one selected from the group consisting of an electric current value and a voltage value at the time of second welding and (ii) presence or absence of an abnormality in a welded part; and
an output process of, in a case where it has been determined in the abnormality determination process that there is an abnormality, outputting a result of the determination and at least one selected from the group consisting of a factor of the abnormality and a remedial method for solving the abnormality.

2. The abnormality diagnosis apparatus according to claim 1, wherein:
the abnormality determination model used in the abnormality determination process
converts time series data into a feature value,
retrieves, from among a plurality of feature values accumulated in advance, a feature value similar to the feature value obtained by converting the time series data, and
generates, with reference to a label given to the feature value which has been retrieved, information pertaining to whether or not there is an abnormality in a welded part at the time of the first welding.

3. The abnormality diagnosis apparatus according to claim 2, wherein:
the information pertaining to whether or not there is an abnormality includes information indicating at least one selected from the group consisting of
an undercut in which an edge part of a weld bead is dented,
an overlap in which an edge part of a weld bead is formed outside the welded part, and
an incomplete penetration in which a weld bead is not formed at a bottom part of the welded part.

4. The abnormality diagnosis apparatus, according to, claim 1, wherein:
in the acquisition process, the at least one processor acquires training data containing a label and time series data which contains at least one selected from the group consisting of an electric current value and a voltage value at the time of the second welding; and
the at least one processor carrying out a training process of training the abnormality determination model with use of the training data.

5. The abnormality diagnosis apparatus according to, claim 1, wherein:
in the output process, the at least one processor further outputs, at the time of the first welding, control information corresponding to a remedial method for solving an abnormality of the welded part.

6. The abnormality diagnosis apparatus according to, claim 1, wherein:
the time series data at the time of the first welding includes a plurality of pieces of time series data which include first time series data and second time series data and which are respectively acquired for a plurality of electrodes included in a welding machine.

7. The abnormality diagnosis apparatus according to claim 6, wherein:
in the acquisition process, the at least one processor generates shifted time series data at the time of the first welding by relatively shifting, in a time direction, the first time series data and the second time series data in the time series data at the time of the first welding; and
in the abnormality determination process, the at least one processor determines, based on the shifted time series data, whether or not there is an abnormality in the welded part at the time of the first welding.

8. The abnormality diagnosis apparatus according to claim 7, wherein:
in the acquisition process, the at least one processor further acquires velocity information indicating a velocity at the time of the first welding; and
in the acquisition process, the at least one processor relatively shifts the first time series data and the second time series data in the time direction in accordance with the velocity indicated by the velocity information.

9. An abnormality diagnosis method, comprising:
acquiring time series data that contains at least one selected from the group consisting of an electric current value and a voltage value at the time of first welding;
determining, with use of an abnormality determination model and based on the time series data which has been acquired, whether or not there is an abnormality in a welded part at the time of the first welding, the abnormality determination model having learned a relation between (i) time series data containing at least one selected from the group consisting of an electric current value and a voltage value at the time of second welding and (ii) presence or absence of an abnormality in a welded part; and
in a case where it has been determined that there is an abnormality, outputting a result of the determination and at least one selected from the group consisting of a factor of the abnormality and a remedial method for solving the abnormality.

10. A non-transitory storage medium storing a program for causing a computer to carry out:
an acquisition process of acquiring time series data that contains at least one selected from the group consisting of an electric current value and a voltage value at the time of first welding;
an abnormality determination process of determining, with use of an abnormality determination model and based on the time series data which has been acquired in the acquisition process, whether or not there is an abnormality in a welded part at the time of the first welding, the abnormality determination model having learned a relation between (i) time series data containing at least one selected from the group consisting of an electric current value and a voltage value at the time of second welding and (ii) presence or absence of an abnormality in a welded part; and
an output process of, in a case where it has been determined in the abnormality determination process that there is an abnormality, outputting a result of the determination and at least one selected from the group consisting of a factor of the abnormality and a remedial method for solving the abnormality.
